(19) United States
(12) Patent Application Publication
(10) Pub. No.: US 2012/0123812 A1
(43) Pub. Date: May 17, 2012

(54) EVALUATING CUSTOMERS

(75) Inventors: Terry Wayne Hornbaker, Holladay, UT (US); Michael A. Padgen, Salt Lake City, UT (US); Raelynn A. Sink, Lakeville, MN (US); Seth Aaron Horowitz, Salt Lake City, UT (US)

(73) Assignee: ACCENTURE GLOBAL SERVICES LIMITED, Dublin (IE)

(21) Appl. No.: 12/948,458

(22) Filed: Nov. 17, 2010

(51) Int. Cl. G06Q 10/00

(52) U.S. Cl. 705/5; 705/1.1

(57) ABSTRACT

Scarce resources, such as goods and/or services, can be allocated to customers according to score values associated with each customer that is a candidate to receive such resources in order to achieve an optimal allocation of resources, as determined by a business or other entity or organization that provides the goods and/or services. Each score value is generated automatically according to a set of predetermined rules based on profile information associated with the customer, including attributes of the customer, and based on information regarding goods and/or services purchased by the customer. A current context is used to determine an event and/or an event class, and the set of rules associated with the event or event class is used in generating the score value for one or more customers that are implicated by the current context, such as individuals affected by or eligible for the event.

### TECHNICAL FIELD

This disclosure relates to evaluating customers.

### BACKGROUND

In some situations, businesses or other organizations wish to rank customers or other affiliated individuals or organizations. For example, where a business has a limited inventory of goods and/or where certain items of inventory are in greater demand, such as season tickets for a professional sports team, the business may want to provide existing customers with their first choice of tickets before offering tickets to new customers. Similarly, the existing customers with the longest history of season ticket purchase may be offered a selection of available tickets before existing customers with fewer years of season ticket purchases.

In addition to duration of the customer relationship, businesses may prioritize customers according to other criteria, such as frequency of purchases. For example, airlines often prioritize customers according to level of a frequent flier program that the customer has attained in the preceding program accounting period. Customers that have attained higher program levels may be offered goods or services ahead of other customers. For example, seat upgrades to first class may be allocated according to frequent flier program level.

### SUMMARY

Scarce resources, such as goods and/or services, can be allocated to customers according to score values associated with each customer that is a candidate to receive such resources in order to achieve an optimal allocation of resources, as determined by a business or other entity or organization that provides the goods and/or services. Each score value is generated automatically according to a set of predetermined rules based on profile information associated with the customer and based on information regarding goods and/or services purchased by the customer. A current context is used to determine an event and/or an event class, and the set of rules associated with the event or event class is used in generating the score value for one or more customers that are implicated by the current context, such as individuals affected by or eligible for the event.

For example, if an airline flight is delayed or cancelled, such as due to inclement weather, the passengers and/or cargo scheduled for journey on the delayed or cancelled flight may need to be re-scheduled on different flights and/or other travel arrangements may need to be made. In order to allocate seats on available alternative flights, a representative of the airline operating the delayed or cancelled flight, such as a gate agent, can initiate an automated batch re-accommodation process for the passengers of the delayed or cancelled flight. The process involves identifying the individuals and/or cargo items affected by the delay or cancellation by referring to a flight manifest or other record of individuals and/or cargo items scheduled for journey on the delayed or cancelled flight. Using passengers as an example, the profile information and booking information of the identified individuals is retrieved. Based on the initiation of the batch re-accommodation process, a current context of a delayed or cancelled flight is identified, and a set of predetermined rules associated with batch re-accommodation are retrieved. The predetermined rules are used to generate a score value for each identified individual, for use in allocating available seats on available alternative flights in the batch re-accommodation process. The available seats on available flights are then allocated to the identified individuals beginning with the most desirable or highest value available seat and the individual receiving the highest score value, and proceeding in descending order. Similarly, rental cars, hotel rooms, travel vouchers, and/or other goods or services can be allocated according to a similar process, or within the same batch re-accommodation process, as necessary. For example, the number of available seats on available flights on the same day as a cancelled flight may be fewer than the number of passengers that need to be re-accommodated. In this case, the batch re-accommodation process may automatically allocate hotel rooms to those individuals who are allocated seats on flights scheduled for a subsequent day.

In a different situation, such as where unsold first class seats are available, a different set of rules can be used to generate score values for customers who are candidates to receive a seat upgrade. Thus, businesses and other entities and organizations can create a different set of predetermined rules for each event or event class for which they wish to score customers differently.

In one general aspect, a computer-implemented method includes identifying an individual, retrieving profile information associated with the individual, retrieving booking information associated with the identifier, identifying at least one of an event and an event class associated with the identifier, selecting at least one of a scoring rule and a set of scoring rules based on at least one of the identified event and the identified event class, and generating, by at least one computer processor, a score value associated with the individual. The score value may be generated based on at least one of the profile information and the booking information and according to at least one of the selected scoring rule and the selected set of scoring rules.

Implementations can include one or more of the following features. For example, the method can include allocating a good or service to the individual based on the score value. Allocating a good or a service to the individual may include allocating a good or service to the individual based on at least one of a comparison of the score value associated with the individual with a threshold value and a comparison of the score value associated with the individual with a second score value associated with a second individual. The second score value may be generated based on second profile information associated with the second individual and second booking information associated with the second individual, and the second score value is generated according to the at least one selected scoring rule or set of scoring rules. The method can also include generating a second score value associated with the individual according to at least one of a second scoring rule and a second set of scoring rules, the score value being associated with a first event and the second score value being associated with a second, different event. When the identified event is the first event, a good or service is allocated to the individual based on the score value and, when the identified event is the second event, a good or service is allocated to the individual based on the second score value. The method can also include creating a record of the score value for use in allocating a good or service to the individual, receiving a request to generate a second score value, the request including one or more scoring rules, and generating a second score value in response to the request according to the one or more scoring rules included in the request. The good or service includes a travel-related good or service, the profile information includes historical travel information associated with the individual, and the booking information includes information regarding a travel-related booking. The event or the event class is selected from the group consisting of a seat assignment event, a schedule change event, a batch seat assignment, a batch seat re-assignment operation, a batch re-accommodation operation for a cancellation, a standby seat assignment operation, an upgrade seat assignment operation, and an advance travel offer allocation operation. The event or the event class is related to a travel business function that involves allocation of at least one good or service.

In another general aspect, a system includes at least one computer processor, and a tangible storage medium having a computer program product stored thereon that, when executed by at least one computer processor causes the system to identify an individual, retrieve profile information associated with the individual, retrieve booking information associated with the identifier, identify at least one of an event and an event class associated with the identifier, select at least one of a scoring rule and a set of scoring rules based on at least one of the identified event and the identified event class, and generate, by at least one computer processor, a score value associated with the individual. The score value may be generated based on at least one of the profile information and the booking information and according to at least one of the selected scoring rule and the selected set of scoring rules.

Implementations can include one or more of the following features. For example, the system allocates a good or service to the individual based on the score value. A good or service may be allocated to the individual based on at least one of a comparison of the score value associated with the individual with a threshold value and a comparison of the score value associated with the individual to a second score value associated with a second individual. The second score value may be generated based on second profile information associated with the second individual and second booking information associated with the second individual, and wherein the second score value may be generated according to the at least one selected scoring rule or set of scoring rules. A second score value associated with the individual may be generated according to at least one of a second scoring rule and a second set of scoring rules, the score value being associated with a first event and the second score value being associated with a second, different event. When the identified event is the first event, a good or service is allocated to the individual based on the score value and, when the identified event is the second event, a good or service is allocated to the individual based on the second score value. A record of the score value may be created for use in allocating a good or service to the individual, and, in response to receiving a request to generate a second score value, a second score value is generated according to one or more scoring rules included in the request. The good or service includes a travel-related good or service, the profile information includes historical travel information associated with the individual, and the booking information includes information regarding travel-related booking. The event or the event class may be selected from the group consisting of a seat assignment event, a schedule change event, a batch seat assignment, a batch seat re-assignment operation, a batch re-accommodation operation for a cancellation, a standby seat assignment operation, an upgrade seat assignment operation, and an advance travel offer allocation operation. The event or the event class is related to a travel business function that involves allocation of at least one good or service.

In another general aspect, a system for allocating travel-related goods or services includes a data structure embodied on a tangible storage medium, the data structure including, for each of a plurality of passengers, passenger score values associated with the passenger, each score value for the passenger being associated with a unique event or an event type, and a processor configured to allocate a good or service to an individual based on a current event or a current event type and at least one of the passenger score values that is associated with the individual and that corresponds to the current event or current event type.

The details of one or more implementations are set forth in the accompanying drawings and the description below. Other features will be apparent from the description and drawings, and from the claims.

### DESCRIPTION OF DRAWINGS

FIG. 1 is a diagram of a scoring system.

FIG. 2 is flow chart illustrating a process for scoring candidate individuals.

FIG. 3 is a diagram of system for managing airline travel.

FIG. 4 is a diagram illustrating a data structure for storing scoring rule information.

FIG. 5 is a diagram illustrating a data structure for storing profile information.

FIG. 6 is a diagram illustrating a data structure for storing booking information.

FIG. 7 is a flow chart illustrating a process for re-accommodating passengers affected by an interruption of regular flight operations.

FIG. 8 is a diagram of a computer.

Like reference symbols in the various drawings indicate like elements.

### DETAILED DESCRIPTION

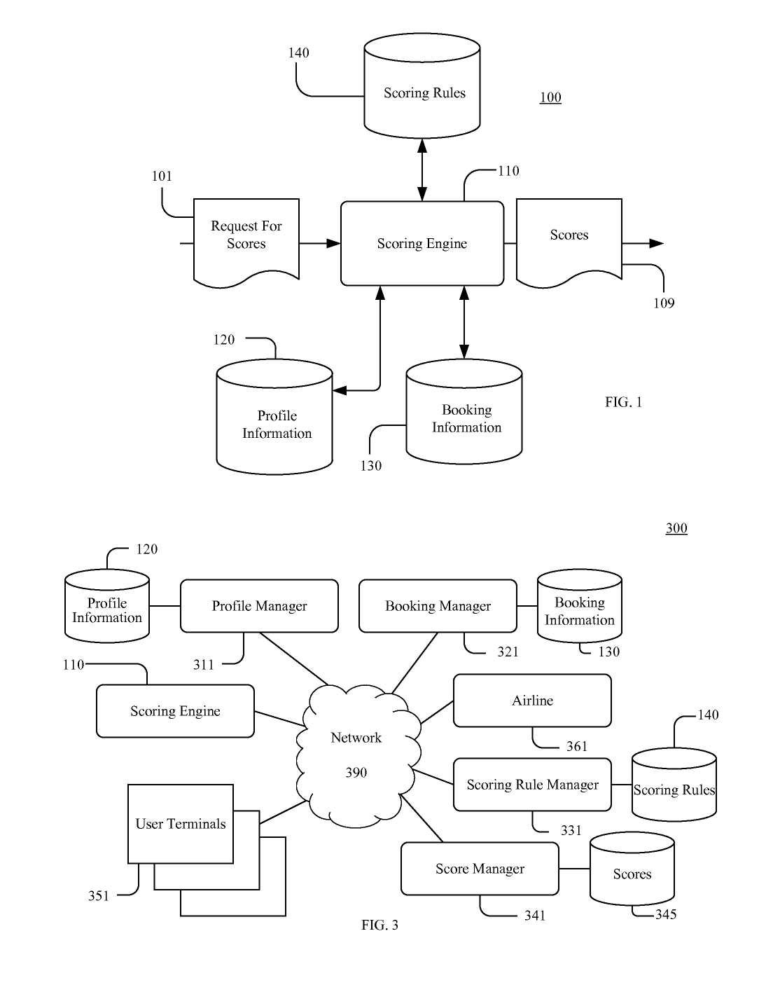

Referring to FIG. 1, a system 100 for generating score values includes a scoring engine 110, a profile information repository 120, a booking information repository 130, and a scoring rule repository 140. The scoring engine 110 is operable to receive a request 101 for one or more score values, and to generate a response 109 that includes the requested one or more score values. For example, when a customer purchases a good or service, such as an airline flight, the airline operator may automatically request score values to be associated with the customer and to be used in allocating resources among customers in various situations. In this example, the request 101 includes information identifying the individual and identifying the airline operator, and the response 109 includes a score value associated with the customer for each event or event class for which the airline operator has provided a scoring rule or rule set.

The scoring engine 110 includes one or more computer processors operable to execute one or more computer programs to receive the request 101 and extract information included in the request 101. The scoring engine is also operable to interact with the profile information repository 120, the booking information repository 130, and the scoring rule repository 140. For example, the scoring engine 110 can retrieve profile information for one or more individuals identified in the request 101 from the profile information repository 120, retrieve booking information for the one or more individuals identified in the request 101 from the booking information repository 130, and retrieve appropriate scoring rules associated with the airline operator from the scoring rule repository 140. The scoring engine also generates score values based on the retrieved scoring rules, the profile information, and/or the booking information, and outputs the generated scores in the response 109.

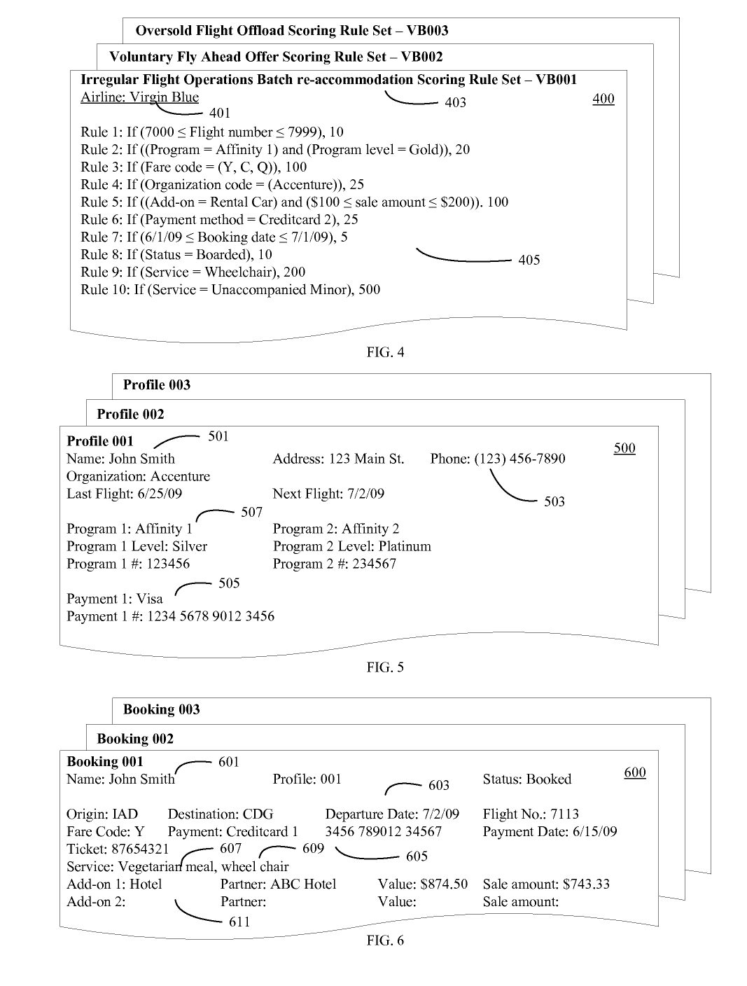

With reference to FIGS. 4-6, the profile information repository 120, the booking repository 130, and the scoring rule repository 140 each includes a computer readable storage device that includes a data structure in which information is stored. The profile information repository 120 includes a data structure 500 that includes information regarding an individual that is a customer of a business or other organization that uses the system 100 to score customers. The profile information can include, for example, the individuals name 501, contact information 503, and persistent account information, such as payment information 505, historical account activity information 507, preference information, and/or notes or annotations provided by the business. The booking information repository 130 includes a data structure 600 that includes information regarding sales transactions associated with the business and the customers. For example, for each sale transaction, the booking information includes information regarding the individual associated with the transaction 601, such as the individual's name. The booking information also includes information regarding the goods and/or services sold 603, payment information 605, and information regarding any special requests 607, accommodations 609, and related goods and/or services provided by another business 611, such as a partner business. The scoring rule repository 140 includes a data structure 400 that includes scoring rule information regarding how a score value is to be created based on a current event and an associated business or other organization. For example, for each event or event class, the scoring rule information includes information regarding a business 401 for whom one or more scoring rules are to be used, and information regarding one or more events or classes of events 403 for which the one or more scoring rules are to be used. The scoring rule information also includes one or more rules 405 that are used to generate a score value based on profile and/or booking information.

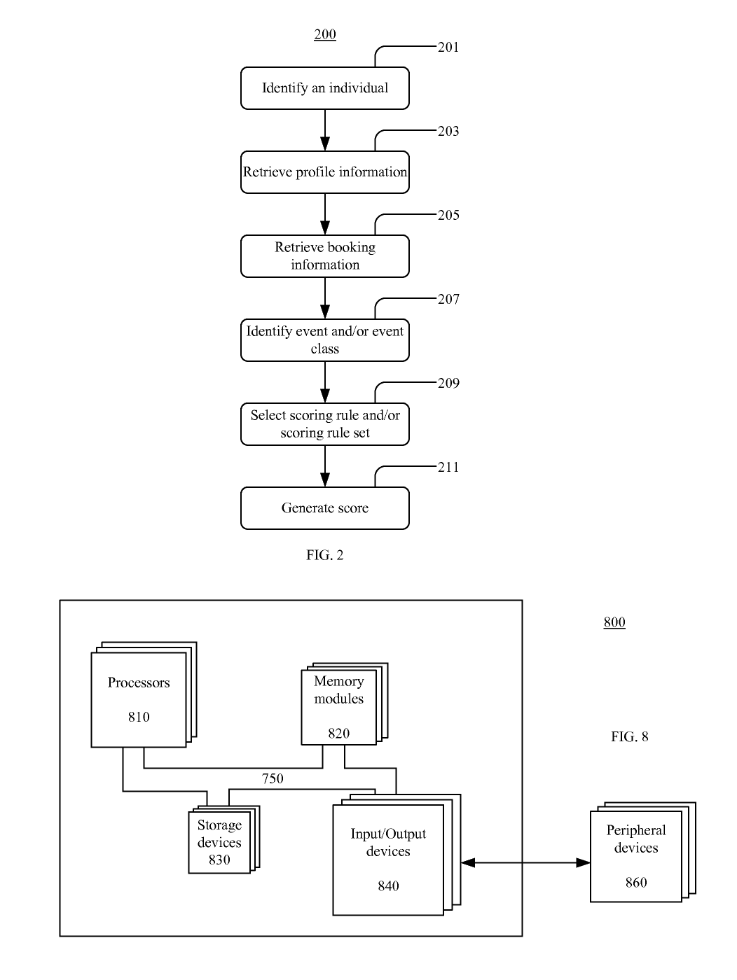

The scoring engine 110 can generate score values according to a process 200 shown in FIG. 2. The process 200 begins when the scoring engine 110 identifies an individual for whom a score value is to be generated (201). The scoring engine 110 can receive the identifier, for example, automatically in response to completion of a new sale transaction, at a predetermined time before a time of delivery of a good or service, in response to the occurrence of an event, or on demand in response to a user-generated request. The identifier can take the form of an individual's name, an arbitrary identifier associated with the individual in the profile information and/or the booking information, such as an account number a booking number, or an identifier of a good or service associated with the individual. For example, the identifier can include a flight number of flight scheduled to depart within a threshold amount of time from the current time, and the flight number can serve to identify each individual scheduled for journey on the identified flight.

After receiving the identifier, the scoring engine 110 retrieves profile information from the profile information repository 120 for each individual identified by the identifier (203). The scoring engine 110 also retrieves booking information from the booking information repository 130 for each individual identified by the identifier (205). The scoring engine 110 identifies one or more events and/or event classes (207) and selects one or more scoring rules from the scoring rule repository 140 based on the identified events and/or event classes (209). The scoring engine 110 then generates a score value for each identified individual for each identified event or event class according to the scoring rule or rule set associated with the event or event class (211).

With reference to FIG. 3, the scoring engine 110 can generate score values according to the process 200 in the system 300 for managing airline travel. The system 300 includes a profile manager computer 311, a booking manager computer 321, a scoring rule manager computer 331, a score manager computer 341, user terminals 351, and an airline 361 connected by a computer network 390.

The airline 361 interacts with the scoring rule manager 331 to create scoring rules or scoring rule sets that are to be used for generating score values for one or more customers in selected events. For example, as illustrated in FIG. 4, the airline 361 created a scoring rule set to be used by the scoring engine 110 to generate a score value that is to be used in a batch re-accommodation process that is initiated in response to an irregular flight operation event. Using the example data structures 400, 500, and 600 illustrated in FIGS. 4-6, the scoring engine 110 would generate a score value of 340 for use in re-accommodating a passenger “John Smith” in the event of a flight cancellation. Specifically, the scoring engine 110 would add 10 points according to Rule 1, since the flight number “7113” is indicated in the information regarding the goods and/or services sold 603, which is between 7000 and 7999. No points would be added according to Rule 2 because John Smith has a “Silver” level in the Affinity 1 program, and a “Gold” level is required. The scoring engine 110 would add 100 points according to Rule 3 because the information regarding the goods and/or services sold 603 includes an indication that the fare code is “Y.” According to Rule 4, the scoring engine 110 would add 25 points because John Smith is associated with the organization “Accenture.” No points would be added according to Rules 5 or 6 because John Smith has not reserved a rental car as an add-on service and because a Creditcard 1 account was used to pay for the travel. The scoring engine 110 would add 5 points according to Rule 7 because the payment date of Jun. 15, 2009 falls between Jun. 1, 2009 and Jul. 1, 2009. No points would be added according to Rule 8 because John Smith has not yet boarded the flight, as indicated by the status “booked” in the booking information. According to Rules 9 and 10, the scoring engine 110 would add 200 points to the score value because John Smith has requested a wheel chair service, but has not required a service for an unaccompanied minor.

The score values generated by the scoring engine 110 can also be tailored in other ways to meet the needs of the airline 361. For example, the scoring rules, the profile information, and the booking information can be configured to allow the scoring engine 110 to generate a different score value or multiple score values for different components of a booking. For example, a booking that involves multiple flight segments, the scoring engine 110 can generate score values for each flight segment. Similarly, if a booking includes multiple products or services, including the add-on services, the scoring engine 110 can generate different scores for use by different organizations.

With continued reference to FIG. 3, when a customer purchases airline travel for a flight operated by the airline 361, the profile manager 311 updates profile information associated with the customer stored in a profile information repository 315, and the booking manager 321 updates booking information stored in a booking information repository 325. If the customer also purchases related goods or services, such as a hotel room and/or a rental car, the profile information and/or the booking information associated with the customer is updated to reflect the purchase of the related goods or services. Additionally, the airline 361, the booking manager 321, or other component of system 300 can automatically send a request to the scoring engine 110 to generate score values associated with the customer for use with regard to the purchased travel. The request can include the name of the customer, a customer identifier, a ticket number or other information to identify the customer and/or the ticket purchase. The request also includes an indication that the request for score values is associated with a new travel purchase.

In response to receiving the request for score values, the scoring engine 110 requests profile information for the customer from the profile manager 311. The profile manager 311 accesses the profile information repository 120 to retrieve the profile information associated with the customer and transmits the retrieved profile information to the scoring engine 110. The scoring engine 110 also requests booking information for the customer from the booking manager 321. The booking manager 321 accesses the booking information repository 130 to retrieve the booking information associated with the customer and transmits the retrieved booking information to the scoring engine 110. Based on the indication that the request for score values is associated with a new travel purchase, the scoring engine 110 requests scoring rule information for one or more predetermined events or event classes that are associated with the airline from the scoring rule manager 331. For example, for new travel purchases, the scoring engine 110 may request scoring rules for all events or event classes associated with the airline. The scoring rule manager 331 accesses the scoring rule repository 140 and retrieves scoring rules for the requested events or event classes.

Using the received scoring rules, profile information, and booking information, the scoring engine 110 generates a score value associated with the customer for each event or event class for which a score value was requested. The scoring engine 110 then sends the generated score values to the score manager 341. The score manager 341 stores the generated score values in a score value repository 345. In some implementations, the score values are stored in the booking information repository 130 along with the booking information. The stored score values can be used for ranking customers, such as for allocation of limited resources. The stored score values can also be updated periodically, in response to a change in the profile information, the booking information, and/or the scoring rules, at a predetermined time relative to the scheduled departure time of the flight, or on demand. Particularly, the scoring engine 110 is operable with an application programmer's interface that allows generation of custom rules or rule sets that can be provided by an airline at the time of a request for score values to generate custom score values for one or more identified customers.

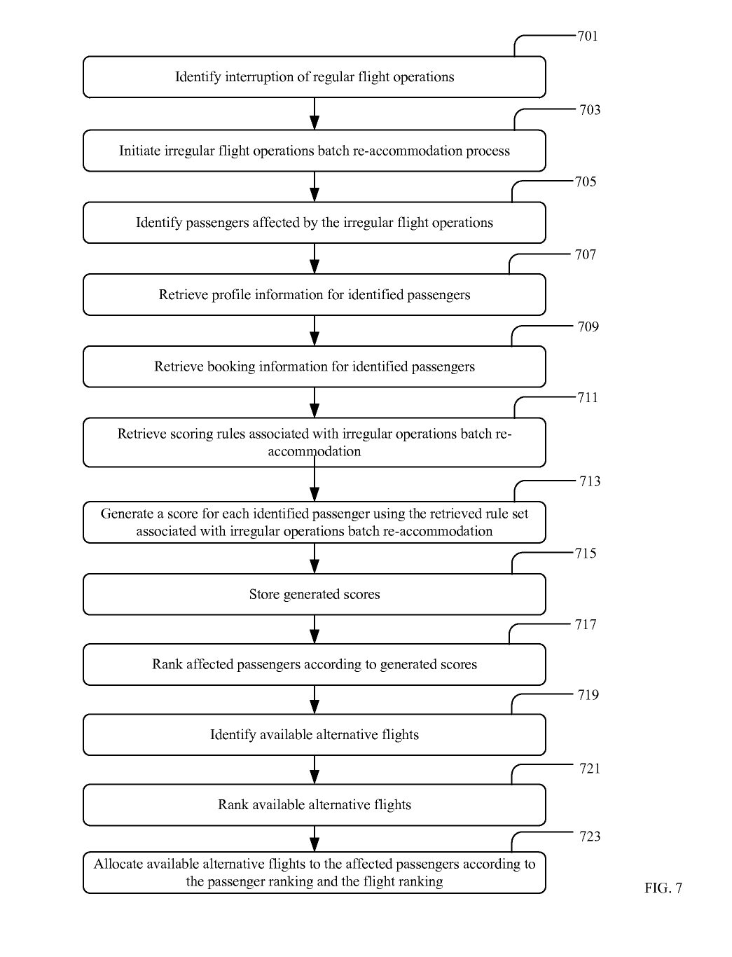

With reference to FIG. 7, upon the occurrence of an event, a user can interact with the system 300 using one of the user terminals 351 to perform an appropriate operation. For example, upon cancellation of a flight, a gate agent of the airline identifies an interruption of regular flight operations (701) and uses a user terminal 351 to initiates an irregular flight operations batch re-accommodation operation (703) to move passengers from the cancelled flight to other available flights. The user terminal 351 identifies the passengers that are affected by the irregular flight operations (705), such as by reference to flight manifest information, or other flight information, which may be stored in the booking information repository 130. The user terminal 351 then transmits one or more requests to the scoring engine 110 requesting a score value for each identified passenger affected by the irregular flight operations.

Upon receiving the one or more requests for score values, the scoring engine 110 retrieves profile information associated with the identified passengers affected by the irregular flight operations (707) and retrieves booking information associated with the identified passengers affected by the irregular flight operations (709). The scoring engine 110 also retrieves scoring rules associated with the irregular operations batch re-accommodation process (711). The scoring engine can determine that the rules associated with the irregular operations batch re-accommodation process are required based on information included in the request, based on the retrieved profile and booking information for the in identified passengers affected by the irregular flight operations, and/or based on flight status information that indicates that the flight has been cancelled.

The scoring engine 110 then generates a score value for each identified passenger affected by the irregular flight operations according to the retrieved scoring rules (713). The generated score values are stored (715) for subsequent processing and/or reference. For example, the user terminal 351 can access the generated score values and rank the identified passengers affected by the irregular operations according to the score values associated with each passenger (717). Additionally, other parameters can be used in ranking the passengers. For example, passengers traveling together may be ranked according to the highest score value associated with the grouped individuals, such as where each member of a family traveling together is ranked as if their associated score value was the same score value as the highest score value associated with any of the family members. Alternatively, the score values of grouped passengers can be aggregated, such as by adding the score values or through another operation, such that groups of passengers are ranked together, and higher than individual passengers.

The user terminal 351 also identifies available alternative flights on which the identified passengers can travel (719) and ranks the available alternative flights (721). For example, the terminal can access booking information to determine whether later flights have available seats for travel to the destination of the cancelled flight, which can include combinations of later flights. The alternative flights can be ranked according to a determination of impact on the itinerary. For example, an alternative flight (or combination of flights) that includes a scheduled arrival time at the destination of the cancelled flight that is closest to the scheduled arrival time of the cancelled flight can be ranked highest. The user terminal 351 then allocates the available seats on alternative flights to the passengers (723). For example, the available seats can be allocated to the passengers in descending order, beginning with the highest ranked available seat and the highest ranked passenger.

Additionally, other resources can be allocated to the passengers according to the ranking. For example, if the number of available flights on the same day as the cancelled flight is less than the number of passengers, hotel rooms or other resources can be allocated to the passengers for whom an allocated alternative flight is scheduled for a subsequent day. Similarly, if a change to a passenger's itinerary requires modification or cancellation of one or more add-on purchases, such modifications or cancellations can automatically be performed after or as part of the re-accommodation operation.

Referring to FIG. 8, the scoring engine 110 and/or components thereof, and one or more components of the system 300, can include one or more computer systems, such as the computer system 800 of FIG. 8, or components thereof. The computer system 800 includes one or more processors 810, memory modules 820, storage devices 830, and input/output devices 840 connected by a system bus 850. The input/output devices 840 are operable with one or more peripheral devices 860, including a communication device that is operable to communicate with other computer systems or components thereof. Other peripheral device that may be included in the computer system 800 include output devices such as displays, speakers, and printers, and input devices such as pointers, microphones, keyboards, and scanners. The one or more computer systems 800 can perform the various functions described in this disclosure by executing computer instructions embodied in computer software stored on a computer-readable storage device, such as the memory modules 820, the storage devices 830, and/or the peripheral devices 860.

While some implementations are described above, these should not be viewed as exhaustive or limiting, but rather should be viewed as exemplary, and are included to provide descriptions of various features. It will be understood that various modifications may be made. For example, the steps of the described exemplary processes can be performed by one or more different entities, systems, and or system components. Similarly, components that are described as separate can be combined, and components can include multiple separate sub-components. Additionally, the scoring rules can use additional or different pieces of information, threshold values, or other criteria in generating the score values, including criteria that depend on other rules and/or score values for different customers. With regard to the processes described above, the steps of the described processes can be performed in any order that achieves the described results. For example, in the process 700, the score values can be pre-generated, such as shortly after booking, or at a predetermined amount of time before a scheduled departure time, such as 72 hours before the scheduled departure. Similarly, the scoring rules can be included in the request for scores such that they can be created or modified dynamically.

A number of implementations have been described. Nevertheless, it will be understood that various modifications may be made without departing from the spirit and scope of the disclosure. Accordingly, other implementations are within the scope of the following claims.

1. A computer-implemented method, comprising:
identifying an individual;
retrieving profile information associated with the individual;
retrieving booking information associated with the identifier;
identifying at least one of an event and an event class associated with the identifier;
selecting at least one of a scoring rule and a set of scoring rules based on at least one of the identified event and the identified event class; and
generating, by at least one computer processor, a score value associated with the individual, the score value being generated based on at least one of the profile information and the booking information and according to at least one of the selected scoring rule and the selected set of scoring rules.

2. The method of claim 1, further comprising allocating a good or service to the individual based on the score value.

3. The method of claim 2, wherein allocating a good or a service to the individual comprises allocating a good or service to the individual based on at least one of a comparison of the score value associated with the individual with a threshold value and a comparison of the score value associated with the individual with a second score value associated with a second individual.

4. The method of claim 3, wherein the second score value is generated based on second profile information associated with the second individual and second booking information associated with the second individual, and wherein the second score value is generated according to the at least one selected scoring rule or set of scoring rules.

5. The method of claim 1, further comprising generating a second score value associated with the individual according to at least one of a second scoring rule and a second set of scoring rules, the score value being associated with a first event and the second score value being associated with a second, different event.

6. The method of claim 5, further comprising allocating, when the identified event is the first event, a good or service to the individual based on the score value and allocating, when the identified event is the second event, a good or service to the individual based on the second score value.

7. The method of claim 1, further comprising creating a record of the score value for use in allocating a good or service to the individual, receiving a request to generate a second score value, the request including one or more scoring rules, and generating a second score value in response to the request according to the one or more scoring rules included in the request.

8. The method of claim 2, wherein the good or service includes a travel-related good or service, the profile information includes historical travel information associated with the individual, and the booking information includes information regarding a travel-related booking.

9. The method of claim 1, wherein the event or the event class is selected from the group consisting of a seat assignment event, a schedule change event, a batch seat assignment, a batch seat re-assignment operation, a batch re-accommodation operation for a cancellation, a standby seat assignment operation, an upgrade seat assignment operation, and an advance travel offer allocation operation.

10. The method of claim 1, wherein the event or the event class is related to a travel business function that involves allocation of at least one good or service.

11. A system, comprising:
at least one computer processor; and
a tangible storage medium having a computer program product stored thereon that, when executed by at least one computer processor, causes the system to:
identify an individual;
retrieve profile information associated with the individual;
retrieve booking information associated with the identifier;
identify at least one of an event and an event class associated with the identifier;
select at least one of a scoring rule and a set of scoring rules based on at least one of the identified event and the identified event class; and
generate, by at least one computer processor, a score value associated with the individual, the score value being generated based on at least one of the profile information and the booking information and according to at least one of the selected scoring rule and the selected set of scoring rules.

12. The system of claim 11, wherein the system allocates a good or service to the individual based on the score value.

13. The system of claim 12, wherein a good or service is allocated to the individual based on at least one of a comparison of the score value associated with the individual with a threshold value and a comparison of the score value associated with the individual to a second score value associated with a second individual.

14. The system of claim 13, wherein the second score value is generated based on second profile information associated with the second individual and second booking information associated with the second individual, and wherein the second score value is generated according to the at least one selected scoring rule or set of scoring rules.

15. The system of claim 11, wherein a second score value associated with the individual is generated according to at least one of a second scoring rule and a second set of scoring rules, the score value being associated with a first event and the second score value being associated with a second, different event.

16. The system of claim 15, wherein, when the identified event is the first event, a good or service is allocated to the individual based on the score value and, when the identified event is the second event, a good or service is allocated to the individual based on the second score value.

17. The system of claim 11, wherein a record of the score value is created for use in allocating a good or service to the individual, and wherein, in response to receiving a request to generate a second score value, a second score value is generated according to one or more scoring rules included in the request.

18. The system of claim 12, wherein the good or service includes a travel-related good or service, the profile information includes historical travel information associated with the individual, and the booking information includes information regarding travel-related booking.

19. The system of claim 11, wherein the event or the event class is selected from the group consisting of a seat assignment event, a schedule change event, a batch seat assignment, a batch seat re-assignment operation, a batch re-accommodation operation for a cancellation, a standby seat assignment operation, an upgrade seat assignment operation, and an advance travel offer allocation operation.

20. The system of claim 11, wherein the event or the event class is related to a travel business function that involves allocation of at least one good or service.

21. A system for allocating travel-related goods or services, the system comprising:
a data structure embodied on a tangible storage medium, the data structure including, for each of a plurality of passengers, passenger score values associated with the passenger, each score value for the passenger being associated with a unique event or an event type; and
a processor configured to allocate a good or service to an individual based on a current event or a current event type and at least one of the passenger score values that is associated with the individual and that corresponds to the current event or current event type.
